(19) United States
(12) Patent Application Publication
(10) Pub. No.: US 2019/0009904 A1
(43) Pub. Date: Jan. 10, 2019

(54) SYSTEMS AND METHODS FOR FACILITATING SAFE EMERGENCY LANDINGS OF UNMANNED AERIAL VEHICLES

(71) Applicant: Walmart Apollo, LLC, Bentonville, AR (US)

(72) Inventors: David C. Winkle, Bella Vista, AR (US); John J. O'Brien, Farmington, AR (US); Donald R. High, Noel, MO (US); Todd D. Mattingly, Bentonville, AR (US)

(21) Appl. No.: 16/011,268

(22) Filed: Jun. 18, 2018

Related U.S. Application Data
(60) Provisional application No. 62/529,699, filed on Jul. 7, 2017.

(51) Int. Cl. B64C 39/02; G05D 1/00; G05D 1/06

(52) U.S. Cl. CPC B64C 39/024; G05D 1/0055; B64C 2201/18; B64C 2201/128; B64C 2201/141; G05D 1/0676

(57) ABSTRACT

In some embodiments, methods and systems are provided that provide for facilitating s safe emergency landing of unmanned aerial vehicles (UAVs) and that include UAVs configured to transport products to delivery destination via flight routes. Each UAV includes sensors configured to detect at least one status input associated with the UAV during flight along its flight route. Each UAV analyzes the status inputs while in flight in order to determine an emergency landing location where the UAV would land if unable to fly due to an emergency condition. The UAV also includes a control circuit that evaluates collateral damage associated with the landing of the UAV at the determined emergency landing location, and that can alter the flight route of the UAV to an alternative delivery route associated with an alternative emergency landing location if the alternative emergency landing location is predicted to have a lower collateral damage as compared to the determined emergency landing location.

### RELATED APPLICATIONS

This application claims the benefit of U.S. Provisional Application No. 62/529,699, filed Jul. 7, 2017, which is incorporated herein by reference in its entirety.

### TECHNICAL FIELD

This disclosure relates generally to facilitating the landings of unmanned aerial vehicles and, in particular, to facilitating safe emergency landings of unmanned aerial vehicles.

### BACKGROUND

When designing systems for transporting products via unmanned aerial vehicles (UAVs), it is conventional to determine a travel path for the UAVs based on the starting point (e.g., deployment station) and the end point (e.g., delivery destination). In some situations, the shortest travel path is chosen, taking into account the relevant starting point and end point global positioning system (GPS) coordinates, possible flight zone restrictions and in-air and on-ground obstacles. Given that the UAVs, both when empty and when carrying cargo, can present a significant injury risk to people and animals on the ground as well as a personal property risk to buildings and cars on the ground in the event that the UAVs crash land, especially in a densely populated area such as a city, optimization of flight routes to reduce such risks is desirable.

### BRIEF DESCRIPTION OF THE DRAWINGS

Disclosed herein are embodiments of systems, apparatuses, and methods pertaining to facilitating a safe emergency landing of unmanned aerial vehicles flying along flight routes. This description includes drawings, wherein:

FIG. 1 is a diagram of a system for facilitating a safe emergency landing of unmanned aerial vehicles flying along flight routes in accordance with some embodiments;

FIG. 2 is a functional diagram of an exemplary computing device usable with the system of FIG. 1 in accordance with some embodiments;

FIG. 3 comprises a block diagram of an unmanned aerial vehicle as configured in accordance with some embodiments; and

FIG. 4 is a flow chart diagram of a process of facilitating a safe emergency landing of unmanned aerial vehicles flying along flight routes in accordance with some embodiments.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems, apparatuses, and methods are provided for predicting an emergency landing location of an unmanned aerial vehicle in the event that the UAV is unable to continue to fly along its predetermined flight route due to an emergency, and altering the predetermined flight route of the UAV, when necessary, to facilitate the UAV to land in an emergency landing location associated with a lower collateral damage (e.g., personal injury and/or property damage) resulting from the UAV landing at the predicted emergency landing location.

In some embodiments, a system for facilitating a safe emergency landing of unmanned aerial vehicles flying along flight routes is provided. The system includes an unmanned aerial vehicle configured to transport at least one product to a delivery destination via a flight route. The UAV includes at least one sensor configured to detect and transmit over a network at least one status input associated with the unmanned aerial vehicle during flight along the flight route. The system also includes a computing device including a processor-based control unit and in communication with the unmanned aerial vehicle over the network. The computing device is configured to: determine the flight route for the unmanned aerial vehicle to deliver the at least one product to the delivery destination; transmit a first control signal over the network to the unmanned aerial vehicle, the first control signal including the determined flight route; and analyze the determined flight route of the unmanned aerial vehicle, prior to deployment of the unmanned aerial vehicle, in order to determine an emergency landing location where the unmanned aerial vehicle would land if unable to fly due to an emergency condition at a given point along the determined flight route The unmanned aerial vehicle includes a processor-based control circuit configured to: analyze the at least one status input while the unmanned aerial vehicle is in flight in order to determine the emergency landing location where the unmanned aerial vehicle would land if unable to fly due to an emergency condition at a given point along the determined flight route; evaluate collateral damage associated with the determined emergency landing of the unmanned aerial vehicle at the determined emergency landing location; and alter the flight route of the unmanned aerial vehicle to an alternative emergency landing location in response to a determination, by the control circuit of the unmanned aerial vehicle, that the alternative emergency landing location is associated with lower collateral damage compared to the determined emergency landing location.

In other embodiments, a method for facilitating a safe emergency landing of unmanned aerial vehicles flying along flight routes comprises: providing an unmanned aerial vehicle configured to transport at least one product to a delivery destination via a flight route, the unmanned aerial vehicle including at least one sensor configured to detect and transmit over a network at least one status input associated with the unmanned aerial vehicle during flight along the flight route; providing a computing device including a processor-based control unit and in communication with the unmanned aerial vehicle over the network; determining, via the computing device, the flight route for the unmanned aerial vehicle to deliver the at least one product to the delivery destination; analyzing, via the computing device, the determined flight route of the unmanned aerial vehicle, prior to deployment of the unmanned aerial vehicle, in order to determine an emergency landing location where the unmanned aerial vehicle would land if unable to fly due to an emergency condition at a given point along the determined flight route; transmitting, via the computing device, a first control signal over the network to the unmanned aerial vehicle, the first control signal including the determined flight route; analyzing, via a processor-based control circuit of the unmanned aerial vehicle and while the unmanned aerial vehicle is in flight, the at least one status input in order to determine the emergency landing location where the unmanned aerial vehicle would land if unable to fly due to an emergency condition at a given point along the determined flight route; evaluating, via the control circuit of the unmanned aerial vehicle, the collateral damage associated with an emergency landing of the unmanned aerial vehicle at the determined emergency landing location; and altering, via the control circuit of the unmanned aerial vehicle, the flight route of the unmanned aerial vehicle to an alternative emergency landing location in response to a determination, by the control circuit of the unmanned aerial vehicle, that the alternative emergency landing location is associated with lower collateral damage compared to the determined emergency landing location.

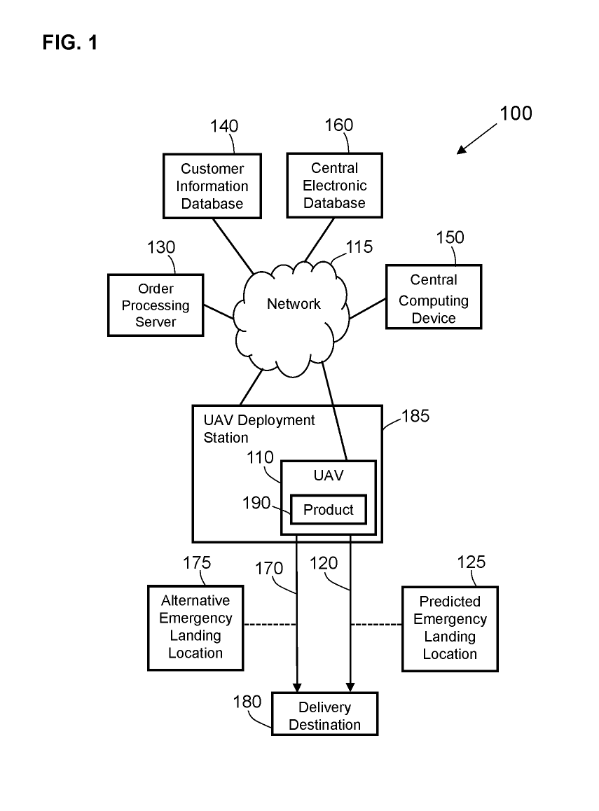

FIG. 1 shows an embodiment of a system 100 for facilitating a safe emergency landing of an unmanned aerial vehicle (UAV) 110 flying along a flight route 120. It will be understood that the details of this example are intended to serve in an illustrative capacity and are not necessarily intended to suggest any limitations in regards to the present teachings. In some aspects, the exemplary UAV 110 of FIG. 1 is configured to transport one or more products 190 from one or more UAV deployment stations 185 to one or more delivery destinations 180 via the flight route 120. In other aspects, the UAV 110 is configured to fly along the flight route 120 from a UAV deployment station 185 to a product pick up location. In yet other aspects, the UAV 110 is configured to fly along the flight route 120 from a delivery destination 180 or a product pick up location back to the UAV deployment station 185.

A customer may be an individual or business entity. A delivery destination 180 may be a home, work place, or another location designated by the customer when placing the order. Exemplary products 190 that may be ordered by the customer via the system 100 may include, but are not limited to, general-purpose consumer goods (retail products and goods not for sale) and consumable products (e.g., food items, medications, or the like). A UAV deployment station 185 can be mobile (e.g., vehicle-mounted) or stationary (e.g., installed at a facility of a retailer). A retailer may be any entity operating as a brick-and-mortar physical location and/or a website accessible, for example, via an intranet, internet, or another network, by way of which products 190 may be ordered by a consumer for delivery via a UAV 110.

The exemplary system 100 depicted in FIG. 1 includes an order processing server 130 configured to process a purchase order by a customer for one or more products 190. It will be appreciated that the order processing server 130 is an optional component of the system 100, and that some embodiments of the system 100 are implemented without incorporating the order processing server 130. The order processing server 130 may be implemented as one server at one location, or as multiple interconnected servers stored at multiple locations operated by the retailer, or for the retailer. As described in more detail below, the order processing server 130 may communicate with one or more electronic devices of system 100 via a network 115. The network 115 may be a wide-area network (WAN), a local area network (LAN), a personal area network (PAN), a wireless local area network (WLAN), Wi-Fi, Zigbee, Bluetooth, or any other internet or intranet network, or combinations of such networks. Generally, communication between various electronic devices of system 100 may take place over hard-wired, cellular, Wi-Fi or Bluetooth networked components or the like. In some embodiments, one or more electronic devices of system 100 may include cloud-based features, such as cloud-based memory storage.

In the embodiment of FIG. 1, the order processing server 130 communicates with a customer information database 140. In some embodiments, the customer information database 140 may be configured to store information associated with customers of the retailer who order products 190 from the retailer. In some embodiments, the customer information database 140 may store electronic information including but not limited to: personal information of the customers, including payment method information, billing address, previous delivery addresses, phone number, product order history, pending order status, product order options, as well as product delivery options (e.g., delivery by UAV) of the customer. The customer information database 140 may be stored, for example, on non-volatile storage media (e.g., a hard drive, flash drive, or removable optical disk) internal or external to the order processing server 130, or internal or external to computing devices separate and distinct from the order processing server 130. It will be appreciated that the customer information database 140 may likewise be cloud-based.

In the embodiment of FIG. 1, the order processing server 130 is in communication with a central electronic database 160 configured to store information associated with the inventory of products 190 made available by the retailer to the customer, as well as information associated with the UAVs 110 being deployed to deliver products 190 to the delivery destinations 180 specified by the customers. In some aspects, the central electronic database 160 stores information including but not limited to: information associated with the products 190 being transported by the UAV 110; inventory (e.g., on-hand, sold, replenishment, etc.) information associated with the products 190; flight status information associated with the UAV 110; information associated with predetermined original flight routes 120 of the UAV 110; status input information detected by one or more sensors of the UAV 110 during flight along the predetermined original flight route 120; information indicating predicted emergency landing locations 125, 175; and information indicating collateral damage associated with one or more predicted emergency landing locations 125, 175 (along an original flight route 120 and along an altered flight route 170) of the UAV 110.

The central electronic database 160 may be stored, for example, on non-volatile storage media (e.g., a hard drive, flash drive, or removable optical disk) internal or external to the order processing server 130, or internal or external to computing devices separate and distinct from the order processing server 130. The central electronic database 160 may likewise be cloud-based. While the customer information database 140 and the central electronic database 160 are shown in FIG. 1 as two separate databases, it will be appreciated that the customer information database 140 and the central electronic database 160 can be incorporated into one database.

With reference to FIG. 1, the central computing device 150 may be a stationary or portable electronic device, for example, a desktop computer, a laptop computer, a tablet, a mobile phone, or any other electronic device including a processor-based control circuit (i.e., control unit). For purposes of this specification, the term “central computing device” will be understood to refer to a computing device owned by the retailer or any computing device owned and/or operated by an entity (e.g., delivery service) having an obligation to deliver products 190 for the retailer. In the embodiment of FIG. 1, the central computing device 150 is configured for data entry and processing as well as for communication with other devices of system 100 via the network 115 which, as described above. In some embodiments, as will be described below, the central computing device 150 is configured to access the central electronic database 160 and/or customer information database 140 via the network 115 to facilitate delivery of products 190 via UAVs 110 along flight routes 120 to delivery destinations 180, and to facilitate safe emergency landings of UAVs 110 in the event that the UAVs 110 are unable to continue flight along the flight routes 120.

In the system 100 of FIG. 1, the central computing device 150 is in two-way communication with the UAV 110 via the network 115. For example, the central computing device 150 can be configured to transmit at least one signal to the UAV 110 to cause the UAV 110 to fly along a flight route 120 determined by the central computing device 150 and/or to deviate from a predetermined flight route 120 while transporting products 190 from the UAV deployment station 185 to the intended delivery destination 180 (e.g., to drop off a product 190 or to pick up a product 190), or while returning from the delivery destination 180 to the UAV deployment station 185 (e.g., after dropping off a product 190 or after picking up a product 190). In some aspects, after a customer places an on order for one or more products 190 and specifies a delivery destination 180 for the products 190 via the order processing server 130, prior to and/or after the commencement of a delivery attempt of the products 190 ordered by the customer via a UAV 110 to the delivery destination 180, the central computing device 150 is configured to obtain GPS coordinates associated with the delivery destination 180 selected by the customer and GPS coordinates associated with the UAV deployment station 185 of the retailer (which houses the UAV 110 that will deliver the products 190), and to determine a flight route 120 for the UAV 110 in order to deliver the customer-ordered products 190 from the UAV deployment station 185 to the delivery destination 180.

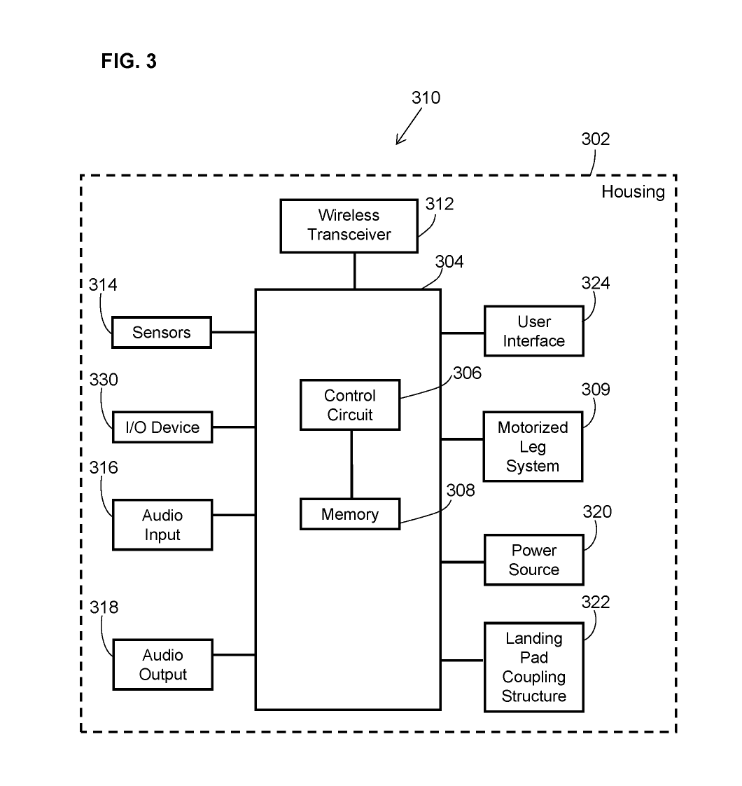

The UAV 110, which will be discussed in more detail below with reference to FIG. 3, is generally an unmanned aerial vehicle configured to autonomously traverse one or more intended environments in accordance with one or more flight routes 120 determined by the central computing device 150, and typically without the intervention of a human or a remote computing device, while retaining the products 190 therein and delivering the products 190 to the delivery destination 180. In some instances, however, a remote operator or a remote computer (e.g., central computing device 150) may temporarily or permanently take over operation of the UAV 110 using feedback information (e.g., audio and/or video content, sensor information, etc.) communicated from the UAV 110 to the remote operator or computer via the network 115, or another similar distributed network. While only one UAV 110 is shown in FIG. 1 for ease of illustration, it will be appreciated that in some embodiments, the central computing device 150 may communicate with, and/or provide flight route instructions to more than one (e.g., 5, 10, 20, 50, 100, 1000, or more) UAVs 110 simultaneously to guide the UAVs 110 to transport products 190 to their respective delivery destinations 180 and/or to facilitate safe emergency landings of the UAVs 110.

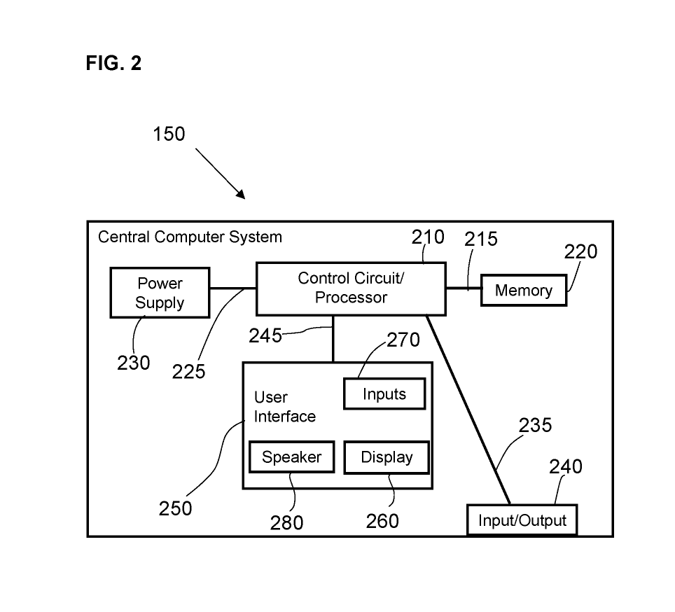

With reference to FIG. 2, an exemplary central computing device 150 configured for use with the systems and methods described herein may include a control unit or control circuit 210 including a processor (for example, a microprocessor or a microcontroller) electrically coupled via a connection 215 to a memory 220 and via a connection 225 to a power supply 230. The control circuit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 210 of the central computing device 150 can be configured (for example, by using corresponding programming stored in the memory 220 as will be well understood by those skilled in the art) to carry out one or more of the steps, actions, and/or functions described herein. In some embodiments, the memory 220 may be integral to the processor-based control circuit 210 or can be physically discrete (in whole or in part) from the control circuit 210 and is configured non-transitorily store the computer instructions that, when executed by the control circuit 210, cause the control circuit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Thus, the memory and/or the control circuit may be referred to as a non-transitory medium or non-transitory computer readable medium.

The control circuit 210 of the central computing device 150 is also electrically coupled via a connection 235 to an input/output 240 that can receive signals from the UAV 110 and/or order processing server 130 and/or customer information database 140 and/or central electronic database 160 (e.g., sensor data representing at least one status input associated with the UAV 110 during flight of the UAV 110 along the flight route 120, data relating to an order for a product 190 placed by the customer, location data (e.g., GPS coordinates) associated with the delivery destination 180 selected by the customer, or from any other source that can communicate with the central computing device 150 via a wired or wireless connection. The input/output 240 of the central computing device 150 can also send signals to the UAV 110 (e.g., a first control signal indicating a flight route 120 (including possible emergency landing locations where the UAV 110 would land if unable to fly due to an emergency condition at a given point along the flight route 120) determined by the central computing device 150 for the UAV 110 in order to deliver the product 190 from the UAV deployment station 185 to the delivery destination 180). The input/output 240 of the central computing device 150 can also send signals to the order processing server 130 (e.g., notification indicating that the UAV 110 was unable to successfully deliver the product 190 to the delivery destination 180 due to an emergency landing) and/or to the central electronic database 160 (e.g., forwarding sensor data received from the UAV 110 or an altered flight route 170 after the UAV 110 is rerouted from its original flight route 120, etc.).

In the embodiment of FIG. 2, the processor-based control circuit 210 of the central computing device 150 is electrically coupled via a connection 245 to a user interface 250, which may include a visual display or display screen 260 (e.g., LED screen) and/or button input 270 that provide the user interface 250 with the ability to permit an operator of the central computing device 150 to manually control the central computing device 150 by inputting commands via touch-screen and/or button operation and/or voice commands to, for example, to transmit a first control signal to the UAV 110 in order to provide the UAV 110 with the flight route 120 from the UAV deployment station 185 to the delivery destination 180. It will be appreciated that the performance of such functions by the processor-based control circuit 210 of the central computing device 150 is not dependent on a human operator, and that the control circuit 210 may be programmed to perform such functions without a human operator.

In some aspects, the display screen 260 of the central computing device 150 is configured to display various graphical interface-based menus, options, and/or alerts that may be transmitted to the central computing device 150 and displayed on the display screen 260 in connection with various aspects of the delivery of the products 190 ordered by the customers by the UAVs 110, as well as various aspects of predicted and actual emergency landings of the UAV 110. The inputs 270 of the central computing device 150 may be configured to permit an operator to navigate through the on-screen menus on the central computing device 150 and change and/or update the flight route 120 of the UAV 110 toward or away from the delivery destination 180 and/or to guide a UAV 110 experiencing an emergency landing toward a predicted emergency landing location 125. It will be appreciated that the display screen 260 may be configured as both a display screen and an input 270 (e.g., a touch-screen that permits an operator to press on the display screen 260 to enter text and/or execute commands.)

In some embodiments, after an order for one or more products 190 is placed by a customer via the order processing server 130, and prior to commencement of the delivery attempt of one or more products 190 via the UAV 110 to the delivery destination 180 designated by the customer, the control circuit 210 of the central computing device 150 is programmed to obtain the GPS coordinates of the delivery destination 180 where the product 190 is to be delivered by the UAV 110. For example, in embodiments, where the customer requested delivery of a product 190 or products 190 to a delivery destination 180 associated with a specific geographic location (e.g., home address, work address, etc.), the control circuit 210 of the central computing device 150 obtains the GPS coordinates associated with the delivery destination 180, for example, from the customer information database 140, or from another source configured to provide GPS coordinates associated with a given physical address.

In some embodiments, the control circuit 210 of the central computing device 150 is configured to analyze the GPS coordinates of both the UAV deployment station 185 and the delivery destination 180, and to determine and generate a flight route 120 for the UAV 110. In one aspect, the flight route 120 determined by the central computing device 150 is based on a starting location of the UAV 110 (e.g., a UAV deployment station 185) and the intended destination of the UAV 110 (e.g., delivery destination 180 and/or product pick up destination). In some aspects, the central computing device 150 is configured to calculate multiple possible flight routes 120 for the UAV 110, and then select a flight route 120 determined by the central computing device 150 to provide an optimal flight time and/or optimal predicted emergency landing locations 125 for the UAV 110 while flying along the original flight route 120. In some embodiments, after the control circuit 210 of the central computing device 150 determines and generates a flight route 120 for the UAV 110, the central computing device 150 transmits, via the output 240 and over the network 115, a first signal including the flight route 120 to the UAV 110 assigned to deliver one or more products 190 from the UAV deployment station 185 to the delivery destination 180.

In some aspects, prior to the UAV 110 being deployed from the UAV deployment station 185, the control circuit 210 of the central computing device 150 s programmed to analyze the determined flight route 120 of the UAV 110 and to predict an emergency landing location 125 where the UAV 110 would land if the UAV 110 is unable to fly due to one or more emergency conditions (that force the UAV 110 to crash land) at any given point along the flight route 120. In some embodiments, after the UAV 110 has been deployed and while the UAV 110 is in flight along a flight route 120 predetermined by the central computing device 150, the control circuit 210 of the central computing device 150 is programmed predict, in real time, emergency landing locations 125 where the UAV 110 would land if the UAV 110 is unable to fly due to one or more emergency conditions at any point along the flight route 120, as well as emergency landing locations 175 where the UAV 110 would land if the UAV 110 is unable to fly due to one or more emergency conditions at any point along one or more alternative flight routes 170, and to alter (e.g., by transmitting a second control signal to the UAV 110) the flight route 120 of the UAV 110 to an alternative flight route 170 associated with an alternative emergency landing location 175 in the event that the control circuit 210 determines that the emergency landing location 175 of the UAV 110 along the altered flight route 170 is associated with less collateral damage than the predicted emergency landing location 125 along the original flight route 120 of the UAV 110.

In some embodiments, the central computing device 150 is capable of integrating 2D and 3D maps of the navigable space of the UAV 110 along the flight route 120 determined by the central computing device 150, complete with topography data comprising: no fly zones along the flight route 120 and on-ground buildings, hills, bodies of water, power lines, roads, vehicles, people, and/or known safe landing points for the UAV 110 along the flight route 120. After the central computing device 150 maps all in-air and on-ground objects along the flight route 120 of the UAV 110 to specific locations using algorithms, measurements, and GPS geo-location, for example, grids may be applied sectioning off the maps into access ways and blocked sections, enabling the UAV 110 to use such grids for navigation and recognition. The grids may be applied to 2D horizontal maps along with 3D models. Such grids may start at a higher unit level and then can be broken down into smaller units of measure by the central computing device 150 when needed to provide more accuracy.

FIG. 3 presents a more detailed exemplary embodiment of the UAV 310 of FIG. 1. In this example, the UAV 310 has a housing 302 that contains (partially or fully) or at least supports and carries a number of components. These components include a control unit 304 comprising a control circuit 306 that, like the control circuit 210 of the central computing device 150, controls the general operations of the UAV 310. The control unit 304 includes a memory 308 coupled to the control circuit 306 for storing data such as operating instructions and/or useful data.

In some embodiments, the control circuit 306 operably couples to a motorized leg system 309. This motorized leg system 309 functions as a locomotion system to permit the UAV 310 to land onto the ground or onto a landing pad at the delivery destination 180 and/or to move laterally at the delivery destination 180 or at an emergency landing location 125 after the UAV 110 crash lands. Various examples of motorized leg systems are known in the art. Further elaboration in these regards is not provided here for the sake of brevity save to note that the control circuit 306 may be configured to control the various operating states of the motorized leg system 309 to thereby control when and how the motorized leg system 309 operates.

In the exemplary embodiment of FIG. 3, the control circuit 306 operably couples to at least one wireless transceiver 312 that operates according to any known wireless protocol. This wireless transceiver 312 can comprise, for example, a cellular-compatible, Wi-Fi-compatible, and/or Bluetooth-compatible transceiver that can wirelessly communicate with the central computing device 150 via the network 115. So configured, the control circuit 306 of the UAV 310 can provide information (e.g., sensor input) to the central computing device 150 (via the network 115) and can receive information and/or movement (e.g., routing and rerouting) instructions from the central computing device 150. These teachings will accommodate using any of a wide variety of wireless technologies as desired and/or as may be appropriate in a given application setting. These teachings will also accommodate employing two or more wireless transceivers 312.

In some embodiments, the wireless transceiver 312 is configured as a two-way transceiver that can receive a signal containing instructions including the flight route 120 and/or rerouting information transmitted from the central computing device 150, and that can transmit one or more signals to the central computing device 150. For example, the control circuit 306 can receive a first control signal from the central computing device 150 via the network 115 containing instructions regarding directional movement of the UAV 310 along a specific, central computing device-determined flight route 120 when, for example: flying from the UAV deployment station 185 to the delivery destination 180 to drop off and/or pick up a product 190, or when returning from the delivery destination 180 after dropping off or picking up a product 190 to the UAV deployment station 185. In particular, as discussed above, the central computing device 150 can be configured to analyze GPS coordinates of the delivery destination 180 designated by the customer, determine a flight route 120 for the UAV 110 to the delivery destination 180, and transmit to the wireless transceiver 312 of the UAV 110 a first control signal including the flight route 120 over the network 115. The UAV 110, after receipt of the first control signal from the central computing device 150, is configured to navigate along the flight route 120, based on the route instructions in the first control signal, to the delivery destination 180.

With reference to FIG. 3, the control circuit 306 of the UAV 310 also couples to one or more on-board sensors 314 of the UAV 310. These teachings will accommodate a wide variety of sensor technologies and form factors. In some embodiments, the on-board sensors 314 can comprise any relevant device that detects and/or transmits at least one status of the UAV 310 during flight of the UAV 110 along the flight route 120. The sensors 314 of the UAV 310 can include but are not limited to: altimeter, velocimeter, thermometer, photocell, battery life sensor, video camera, radar, lidar, laser range finder, and sonar. In some embodiments, the information obtained by one or more sensors 314 of the UAV 310 is used by the UAV 310 and/or the central computing device 150 in functions including but not limited to: navigation, landing, on-the-ground object/people detection, potential in-air threat detection, crash damage assessments, distance measurements, topography mapping, location determination, emergency detection.

In some aspects, the status input detected and/or transmitted by one or more sensors 314 of the UAV 310 includes but is not limited to location data associated with the UAV 310. Such location data can include, for example GPS coordinates of the UAV 310, marker beacon data along the flight route 120, and way point data along the flight route 120, all of which enable the control circuit 210 of the central computing device 150 and/or the control circuit 306 of the UAV 310, based on an analysis of at least such location data, to predict an emergency landing location 125 where the UAV 310 would land if unable to fly due to an emergency condition at a given point along the flight route 120.

In some embodiments, the status input detected and/or transmitted by one or more sensors 314 of the UAV 310 includes, but is not limited to collateral damage aversion directives. In some aspects, the collateral damage aversion directives are weighted and are in the form of the following exemplary hierarchical order: (1) avoid injury to people upon landing at the predicted emergency landing location 125; (2) avoid injury to animals upon landing at the predicted emergency landing location 125; (3) avoid damage to property upon landing at the predicted emergency landing location 125; (4) protect data upon landing at the predicted emergency landing location 125; (5) protect the products 190 being transported by the UAV 310 upon landing at the predicted emergency landing location 125; and (6) protect the UAV 310 upon landing at the predicted emergency landing location 125. In other words, in some aspects, the risk aversion directive having the heaviest weight (i.e., most importance) is the avoidance of injury to people on the ground as a result of the UAV 310 crash landing at the emergency landing location 125.

In some embodiments, the status input detected and/or transmitted by the at least one sensor 314 of the UAV 310 includes UAV status data including but not limited to propeller status, electronics status, communication status, interfering radio frequency (RF) status. For example, the UAV 310 can include at least one sensor 314 configured to monitor the function of, and to detect any malfunction of, any mechanical or electronic component of the UAV 310. In some embodiments, the sensors 314 of the UAV 310 are configured to, for example, detect rotation speed of the propellers of the UAV 310, detect directional movement of the UAV 310, measure ambient temperature surrounding the UAV 310, capture images and/or video in the air around the UAV 310 or on the ground below the UAV 310 along the flight route 120 of the UAV 310, capture thermographic, infrared, and/or multi spectral images of such in-air or on ground objects, capture images of entities attempting to tamper with UAV 310. Such sensors 314 include but are not limited to one or more accelerometers, gyroscopes, odometers, location sensors, microphones, distance measurement sensors (e.g., laser sensors, sonar sensors, sensors that measure distance by emitting and capturing a wireless signal (which can comprise light and/or sound) or the like), 3D scanning sensors, other such sensors, or a combination of two or more of such sensors.

In some embodiments, the status input detected and/or transmitted by the at least one sensor 314 of the UAV 310 includes flight mission data of the UAV 310. Such flight mission data can include but is not limited to: dimensional characteristics of the product(s) 190 being transported by the UAV 310; weight of the product(s) 190 being transported by the UAV 310; total weight of the UAV 310; component configuration of the UAV 310; altitude of the UAV 310; speed of the UAV 310; ambient wind speed; ambient temperature; ambient light level, in-air objects proximate the UAV 310 along the flight route 120; distance of the UAV 310 to the in-air objects; angle of incidence of the UAV 310 relative to the in-air objects; remaining battery life of the UAV 310; start- and end-points of the UAV 310 along the flight route 120; original path of the UAV 310 along the flight route 120; location of one or more mobile relay stations along the flight route 120; location of at least one facility of the retailer having a safe landing point along the flight route 120; total dollar value of the products 190 being transported by the UAV 310; and total dollar value of the UAV 310.

For example, in some aspects, the sensors 314 include one or more devices that can be used to capture data related to one or more in-air objects (e.g., other UAVs 310, helicopters, birds, rocks, etc.) located within a threshold distance relative to the UAV 310. For example, the UAV 310 includes at least one on-board sensor 314 configured to detect at least one obstacle between the UAV 310 and the delivery destination 180 designated by the customer. Based on the detection of one or more obstacles by such a sensor 314, the UAV 310 is configured to avoid the obstacle(s). In some embodiments, the UAV 310 may attempt to avoid detected obstacles, and if unable to avoid, to notify the central computing device 150 of such a condition. In some embodiments, using on-board sensors 314 (such as distance measurement units, e.g., laser or other optical-based distance measurement sensors), the UAV 310 detects obstacles in its path, and flies around such obstacles or stops until the obstacle is clear.

In some aspects, the UAV 310 includes sensors 314 configured to recognize environmental elements along the flight route 120 of the UAV 310 toward and/or away from the delivery destination 180. Such sensors 314 can provide information that the control circuit 306 and/or the central computing device 150 can employ to determine a present location, distance, and/or orientation of the UAV 310 relative to one or more in-air objects and/or objects and surfaces at the delivery destination 180, and/or at the predicted emergency landing location 125. These teachings will accommodate any of a variety of distance measurement units including optical units and sound/ultrasound units. In one example, a sensor 314 comprises an altimeter and/or a laser distance sensor device capable of determining a distance to objects in proximity to the sensor 314. Such information may be processed by the control circuit 306 of the UAV 310 and/or the control circuit 210 of the central computing device 150 in order to determine, for example, whether to direct the UAV 310 to continue flying along the originally determined flight route 120, or whether to direct the UAV 310 to deviate from such a flight route 120 and to fly along an altered flight route 170 calculated by the control circuit 306 of the UAV 310 and/or the control circuit 210 of the central computing device 150 to be associated with one or more emergency landing locations 175 associated with lower predicted collateral damage as compared to the predicted emergency landing locations 125 along the originally determined flight route 120.

In some embodiments, the UAV 310 includes an on-board sensor 314 (e.g., a video camera) configured to detect map reference and/or topography and/or people and/or objects at the predicted emergency landing location 125. For example, in some aspects, one or more map reference or topography data acquired by one or more sensors 314 of the UAV 310 includes but is not limited to: no fly zones along the flight route 120, known safe emergency landing points along the flight route 120, on-the-ground people, buildings, vehicles and/or other objects, as well as hills, bodies of water, power lines, roads, and other environmental factors along the flight route 120 and/or at the predicted emergency landing location 125.

In some embodiments, the sensor 314 of the UAV 310 is configured to transmit (e.g., via internal circuitry and/or via the transceiver 312) still and/or moving images of the predicted emergency landing location 125 to the control circuit 306 of the UAV 110 and/or the control circuit 210 of the central computing device 150, which allows the control circuit 306 of the UAV 310 and/or the control circuit 210 of the central computing device 150 to analyze the detected environmental elements and assess personal injury risk and/or property damage risk associated with the crash landing of the UAV 310 at the predicted emergency landing location 125, and to alter the flight route 120 of the UAV 310 onto an altered flight route 170 associated with an alternative emergency landing location 175 calculated by the control circuit 306 of the UAV 310 and/or the control circuit 210 of the central computing device 150 to be associated with a lower risk of personal injury and/or property damage resulting from such a crash landing.

In some embodiments, an audio input 316 (such as a microphone) and/or an audio output 318 (such as a speaker) can also operably couple to the control circuit 306 of the UAV 310. So configured, the control circuit 306 can provide for a variety of audible sounds to enable the UAV 310 to communicate with, for example, the central computing device 150 or other UAVs, or electronic devices at the emergency landing location 125. Such sounds can include any of a variety of tones and/or sirens and/or other non-verbal sounds. Such audible sounds can also include, in lieu of the foregoing or in combination therewith, pre-recorded or synthesized speech.

In the embodiment illustrated in FIG. 3, the UAV 310 includes a rechargeable power source 320 such as one or more batteries. The power provided by the rechargeable power source 320 can be made available to whichever components of the UAV 310 require electrical energy. By one approach, the UAV 310 includes a plug or other electrically conductive interface that the control circuit 306 can utilize to automatically connect to an external source of electrical energy (e.g., a charging dock) to recharge the rechargeable power source 320.

In some embodiments, the UAV 310 includes an input/output (I/O) device 330 that is coupled to the control circuit 306. The I/O device 330 allows an external device to couple to the control unit 304. The function and purpose of connecting devices will depend on the application. In some examples, devices connecting to the I/O device 330 may add functionality to the control unit 304, allow the exporting of data from the control unit 304, allow the diagnosing of the UAV 310, and so on.

In some embodiments, the UAV 310 includes a user interface 324 including for example, user inputs and/or user outputs or displays depending on the intended interaction with the user (e.g., a worker of a retailer or UAV delivery service or customer). For example, user inputs could include any input device such as buttons, knobs, switches, touch sensitive surfaces or display screens, and so on. Example user outputs include lights, display screens, and so on. The user interface 324 may work together with or separate from any user interface implemented at an optional user interface unit (such as a smart phone or tablet device) usable by the worker.

In some embodiments, the UAV 310 may be controlled by a user in direct proximity to the UAV 310, for example, an operator of the UAV deployment station 185 (e.g., a driver of a moving vehicle), or by a user at any location remote to the location of the UAV 310 (e.g., regional or central hub operator). This is due to the architecture of some embodiments where the central computing device 150 outputs control signals to the UAV 310. These controls signals can originate at any electronic device in communication with the central computing device 150. For example, the signals sent to the UAV 310 may be movement instructions determined by the central computing device 150 and/or initially transmitted by a device of a user to the central computing device 150 and in turn transmitted from the central computing device 150 to the UAV 310.

The control unit 304 of the UAV 310 includes a memory 308 coupled to a control circuit 306 and storing data such as operating instructions and/or other data. The control circuit 306 can comprise a fixed-purpose hard-wired platform or can comprise a partially or wholly programmable platform. These architectural options are well known and understood in the art and require no further description. This control circuit 306 is configured (e.g., by using corresponding programming stored in the memory 308 as will be well understood by those skilled in the art) to carry out one or more of the steps, actions, and/or functions described herein. The memory 308 may be integral to the control circuit 306 or can be physically discrete (in whole or in part) from the control circuit 306 as desired. This memory 308 can also be local with respect to the control circuit 306 (where, for example, both share a common circuit board, chassis, power supply, and/or housing) or can be partially or wholly remote with respect to the control circuit 306. This memory 308 can serve, for example, to non-transitorily store the computer instructions that, when executed by the control circuit 306, cause the control circuit 306 to behave as described herein. It is noted that not all components illustrated in FIG. 3 are included in all embodiments of the UAV 310. That is, some components may be optional depending on the implementation.

As referenced above, after receiving one or more sensor inputs detected by one or more sensors 114 of the UAV 110 while the UAV 110 is in flight along the flight route 120 determined by the central computing device 150, the control circuit 210 of the central computing device 150 is programmed to analyze one or more of the received status inputs in order to determine a predicted emergency landing location 125 where the UAV 110 would land if unable to fly due to an emergency condition at a given point along the flight route 120. Similarly, in some embodiments, the control circuit 306 of the UAV 310 is programmed to analyze one or more status inputs obtained by one or more sensors 314 while the UAV 310 is in normal flight mode and/or facing an imminent emergency condition in order to determine the emergency landing location 125 where the UAV 310 would land if unable to fly due to the emergency condition at a given point along the flight route 120. In some aspects, the control circuit 306 of the UAV 310 is programmed to evaluate collateral damage associated with the landing of the UAV 310 at the predicted emergency landing location 125 and to reroute the UAV 310 to an alternative flight route 170 associated with an alternative emergency landing location 175 determined by the control circuit 306 of the UAV 310 to be associated with lower collateral damage compared to the predicted emergency landing location 125 along the original flight route 120.

In some embodiments, the control circuit 306 of the UAV 310 and/or the control circuit 210 of the central computing device 150 is programmed to predict possible emergency landing locations 125 of the UAV 310 based on possible emergency conditions occurring at any given point along the flight route 120 (or an altered flight route) of the UAV 310, which include analysis of emergency landing locations 125 including but not limited to: an emergency landing location 125, 175 resulting from an unguided ballistic trajectory of the UAV 310 if the UAV 310 loses all power (e.g., the battery of the UAV 310 dies or is otherwise disabled) at any point along the original flight route 120 or an altered flight route 170; an emergency landing location 125, 175 resulting from a collision of the UAV 310 with an in-air object (e.g., bird, rock, other UAV, etc.) that causes the UAV 310 to veer off the original flight route 120 (or off an altered flight route 170) and/or malfunction such that the UAV 310 is not controllable; an emergency landing location 125, 175 resulting from a guided ballistic trajectory of the UAV 310 if the UAV 310 malfunctions or collides with an object at any point along the original flight route 120 (or along an altered flight route 170) but does not lose power and remains controllable by the central computing device 150 and/or the control circuit 306 of the UAV 310 from the point along the original flight route 120 or an altered flight route 170 where the emergency condition occurred to the emergency landing location 125, 175 where the UAV 310 is guided to.

In some embodiments, after the control circuit 210 of the central computing device 150 and/or control circuit 306 of the UAV 310 determines a predicted emergency landing location 125, the control circuit 210 of the central computing device 150 and/or control circuit 306 of the UAV 310 is programmed to calculate a risk of personal injury (e.g., to people and/or animals) associated with the landing of the UAV 310 at the predicted emergency landing location 125. In one aspect, the control circuit 210 of the central computing device 150 and/or control circuit 306 of the UAV 310 is programmed to select, from the predicted possible emergency landing locations 125, an emergency landing location 125 associated with the lowest risk of personal injury associated with the emergency landing of the UAV 110. For example, the control circuit 210 of the central computing device 150 and/or control circuit 306 of the UAV 310 can be programmed to interpret an emergency landing location 125 where no people are present to have the lowest risk of personal injury. In another example, the control circuit 210 of the central computing device 150 and/or control circuit 306 of the UAV 310 can be programmed to interpret an emergency landing location 125 where the smallest number of people are present (compared to the alternative emergency landing locations 175) to have the lowest risk of personal injury.

In some embodiments, after the control circuit 210 of the central computing device 150 and/or control circuit 306 of the UAV 310 determines a predicted emergency landing location 125 of the UAV 310, the control circuit 210 of the central computing device 150 and/or control circuit 306 of the UAV 310 is programmed to calculate a total cost value of property damage (e.g., to products 190, UAV 110, buildings, vehicles, etc.) associated with the landing of the UAV 310 at the predicted emergency landing location 125. In one aspect, the control circuit 210 of the central computing device 150 and/or control circuit 306 of the UAV 310 is programmed to select, from the determined possible emergency landing locations 125, an emergency landing location 125 associated with the lowest cost of property damage occurring as a result of the emergency landing of the UAV 110. For example, the control circuit 210 can be programmed to interpret an emergency landing location 125 where the UAV 310 crash lands onto a piece of land having no vehicles, buildings, or other structures thereon to have the lowest property damage value.

In some embodiments, after the control circuit 210 of the central computing device 150 and/or control circuit 306 of the UAV 310 predicts the possible emergency landing locations 125 of the UAV 310 during the flight of the UAV 310 along the original flight route 120 or an altered flight route, the control circuit 210 of the central computing device 150 and/or control circuit 306 of the UAV 310 is programmed to alter the flight route 120 of the UAV 310 to facilitate the UAV 310 to land at the predicted emergency landing location 125 associated with the lowest collateral damage resulting from the emergency landing of the UAV 310. As discussed above, in one aspect, the control circuit 210 of the computing device 150 is programmed to transmit over the network 115 a second control signal including an altered flight route to the UAV 310.

In some embodiments, the control circuit 210 of the central computing device 150 and/or control circuit 306 of the UAV 310 is programmed to alter the flight route 120 of the UAV 310 prior to the occurrence of the emergency condition in order to enable the UAV 310 to land at an emergency landing location 175 associated with the lowest personal injury risk resulting from the landing of the UAV 110. In another aspect, the control circuit 210 of the computing device 150 is programmed to alter the flight route 120 of the UAV 110 prior to the occurrence of the emergency condition in order to enable the UAV 310 to land at an emergency landing location 125 associated with the lowest combined personal injury risk and property damage cost resulting from the emergency landing of the UAV 310.

In some embodiments, where none of the predicted emergency landing locations 125 associated with movement of the UAV 310 alo310 ng the original flight route 120 present an acceptably low personal injury risk and/or property damage cost, the control circuit 210 of the central computing device 150 and/or control circuit 306 of the UAV 310 is programmed to alter the flight route 120 of the UAV 310 prior to the occurrence of the emergency condition and to guide the UAV 310 to a safe landing location. In some embodiments, where the emergency condition that causes the UAV 310 to undergo an emergency landing is a collision with an in-air object (e.g., a bird, rock, another UAV, helicopter, or the like) the control circuit 210 of the central computing device 150 and/or control circuit 306 of the UAV 310 is programmed to change the orientation and/or shift the position of the UAV 310, if the control circuit 210 of the central computing device 150 and/or control circuit 306 of the UAV 310 determines that such a change and/or shift would reduce the damage to the UAV 310 and/or would prevent the UAV 310 from losing all power and/or suffering a malfunction that causes the UAV 310 to crash land.

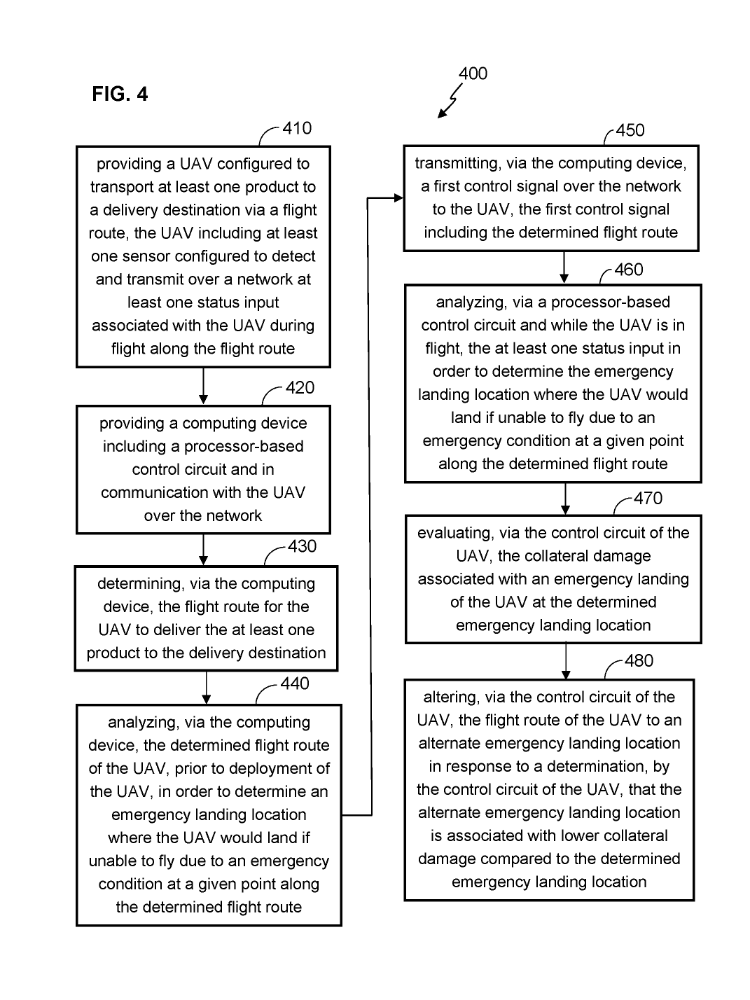

FIG. 4 shows an embodiment of an exemplary method 400 of facilitating a safe emergency landing of UAVs 110 flying along flight routes 120. The embodiment of the method 400 illustrated in FIG. 4 includes providing a UAV 110 configured to transport at least one product 190 to a delivery destination 180 via a flight route 120, with the UAV 110 including at least one sensor 314 configured to detect and transmit over a network 115 at least one status input associated with the UAV 110 during flight along the flight route 120 (step 410). The exemplary method 400 further includes providing a computing device 150 including a processor-based control circuit 210 and in communication with the UAV 110 over the network 115 (step 420).

As discussed above, the central computing device 150 is configured to obtain and analyze the relative locations of the UAV deployment station 185 and delivery destination 180 in order to determine a flight route 120 for the UAV 110 from the UAV deployment station 185 to the delivery destination 180. For example, in some embodiments, the central computing device 150 obtains GPS data associated with the delivery destination 180 from the customer information database 140 and GPS data associated with the UAV deployment station 185 from the central electronic database 160. As discussed above, the customer information database 140 and the central electronic database 160 may be implemented as a single database. After the GPS coordinates of the UAV deployment station 185 and the delivery destination 180 are obtained by the central computing device 150, the exemplary method 400 of FIG. 4 includes determining, via the computing device 150, the flight route 120 for the UAV 110 to deliver the at least one product 190 to the delivery destination 180 (step 430). In some embodiments, the central computing device 150 determines one or more flight routes 120 for the UAV 110 from the UAV deployment station 185 to the delivery destination 180 that is associated with an optimal (e.g., shortest) travel path for the UAV 110 and/or optimal (least collateral damage-associated) predicted emergency landing locations 125 for the UAV 110 while it is traveling along the original flight route 120. To that end, the method 400 of FIG. 4 further includes analyzing, via the central computing device 150, the determined flight route 120 of the UAV 110, prior to deployment of the UAV 110, in order to determine an emergency landing location 125 where the UAV 110 would land if unable to fly due to an emergency condition at a given point along the determined flight route 120 (step 440).

After the route of the UAV 110 to the delivery destination 180 is determined by the central computing device 150, the method 400 further includes transmitting, via the central computing device 150, a first control signal over the network 115 to the UAV 110, with the first control signal including the determined flight route 120 (step 450). As discussed above, it will be appreciated that the route instructions, after being determined by the central computing device 150, can be recalculated by the control circuit 210 of the central computing device 150 (or the control circuit 306 of the UAV 110) in real-time, for example, if an obstacle, no-fly zone, or another movement restriction is detected along the originally calculated flight route 120 of the UAV 110, or if the originally determined flight route 120 is associated with one or more predicted emergency landing locations 125 having higher collateral damage as compared to collateral damage associated with one or more alternative emergency landing locations 175 along an alternative flight route 170.

As discussed above, the on-board sensors 314 of the UAV 310 may include but are not limited to: altimeter, velocimeter, thermometer, photocell, battery life sensor, video camera, radar, lidar, laser range finder, and sonar, and the information obtained by the sensors 314 of the UAV 310 while the UAV 310 is in flight is used by the UAV 310 and/or the central computing device 150 in functions including but not limited to: navigation, landing, on-the-ground object/people detection, potential in-air threat detection, crash damage assessments, distance measurements, topography mapping, location determination, emergency detection. In some aspects, the status input detected and/or transmitted by the sensors 314 of the UAV 310 includes but is not limited to location data associated with the UAV 310 and data relating to potential obstacles, in-air objects, and UAV status information that may be relevant to analysis, by the control circuit 306 of the UAV 310, of potential emergency conditions that may force the UAV 310 to experience a forced emergency landing, as well as of predicted emergency landing location 125 where the UAV 310 would land if unable to fly due to an emergency condition at a given point along the original flight route 120.

As discussed above, in some embodiments, the control circuit 306 of the UAV 310 analyzes one or more status inputs obtained by one or more sensors 314 while the UAV 110 is in normal flight mode and/or facing an imminent emergency condition in order to determine the emergency landing location 125 where the UAV 110 would land if unable to fly due to the emergency condition at a given point along the flight route 120. The method 400 includes analyzing, via a processor-based control circuit 306 of the UAV 310 and while the UAV 310 is in flight, one or more of the status inputs (acquired by the sensors 314 of the UAV 310) in order to determine a predicted emergency landing location 125 where the UAV 310 would land if unable to fly due to an emergency condition at a given point along the determined flight route 120 (step 460). In some aspects, the control circuit 306 of the UAV 310 evaluates collateral damage associated with the landing of the UAV 310 at the predicted emergency landing location 125. To that end, the exemplary method 400 of FIG. 4 further includes evaluating, via the control circuit 306 of the UAV 310, the collateral damage associated with the landing 125 of the UAV 310 at the determined predicted emergency landing location 125 (step 470).

In some embodiments, after the control circuit 210 of the central computing device 150 and/or control circuit 306 of the UAV 310 predicts the possible emergency landing locations 125 of the UAV 310 during the flight of the UAV 310 along the original flight route 120 or an altered flight route, the control circuit 210 of the central computing device 150 and/or control circuit 306 of the UAV 310 is programmed to alter the flight route 120 of the UAV 310 to facilitate the UAV 310 to land at the predicted emergency landing location 125 associated with the lowest collateral damage resulting from the emergency landing of the UAV 310. To that end, the method 400 of FIG. 4 includes altering, via the control circuit 306 of the UAV 310, the flight route 120 of the UAV 310 to an alternative flight route 170 associated with an alternative emergency landing location 175 in response to a determination, by the control circuit 306 of the UAV 310, that the alternative emergency landing location 175 is associated with lower collateral damage compared to the determined emergency landing location (step 480). In one aspect, the control circuit 306 of the UAV 310 alters the flight route 120 of the UAV 310 prior to the occurrence of the emergency condition in order to enable the UAV 310 to land at an emergency landing location 125 associated with the lowest personal injury risk resulting from the landing of the UAV 110. In another aspect, the control circuit 306 of the UAV 310 alters the flight route 120 of the UAV 110 prior to the occurrence of the emergency condition in order to enable the UAV 310 to land at an emergency landing location 125 associated with the lowest combined personal injury risk and property damage cost resulting from the emergency landing of the UAV 310.

The systems and methods described herein advantageously facilitate travel of unmanned aerial vehicles along delivery routes that are calculated to have emergency landing locations associated with lowest predicted collateral damage, both in terms of property damage and personal injury. As such, the systems and methods described herein provide a significant liability cost savings to operators of unmanned aerial vehicles when performing deliveries of products to customers via unmanned aerial vehicles.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for facilitating a safe emergency landing of unmanned aerial vehicles flying along flight routes, the system comprising:
an unmanned aerial vehicle configured to transport at least one product to a delivery destination via a flight route, the unmanned aerial vehicle including at least one sensor configured to detect and transmit over a network at least one status input associated with the unmanned aerial vehicle during flight along the flight route;
a computing device including a processor-based control unit and in communication with the unmanned aerial vehicle over the network, the computing device being configured to:
determine the flight route for the unmanned aerial vehicle to deliver the at least one product to the delivery destination;
transmit a first control signal over the network to the unmanned aerial vehicle, the first control signal including the determined flight route; and
analyze the determined flight route of the unmanned aerial vehicle, prior to deployment of the unmanned aerial vehicle, in order to determine an emergency landing location where the unmanned aerial vehicle would land if unable to fly due to an emergency condition at a given point along the determined flight route;
wherein the unmanned aerial vehicle includes a processor-based control circuit configured to:
analyze the at least one status input while the unmanned aerial vehicle is in flight in order to determine the emergency landing location where the unmanned aerial vehicle would land if unable to fly due to an emergency condition at a given point along the determined flight route;
evaluate collateral damage associated with the determined emergency landing of the unmanned aerial vehicle at the determined emergency landing location; and
alter the flight route of the unmanned aerial vehicle to an alternative emergency landing location in response to a determination, by the control circuit of the unmanned aerial vehicle, that the alternative emergency landing location is associated with lower collateral damage compared to the determined emergency landing location.

2. The system of claim 1, wherein the at least one status input comprises at least one of: (1) weighted collateral damage aversion directives comprising: avoid personal injury upon landing, avoid damage to property upon landing, protect data upon landing, protect the at least one product upon landing, and protect the unmanned aerial vehicle upon landing; (2) drone status data comprising: propeller status, electronics status, communication status, interfering RF status; (3) map reference and topography data comprising: no fly zones along the flight route and on-ground buildings, hills, bodies of water, power lines, roads, vehicles, people, and known safe landing points along the flight route; (4) location data comprising: global positioning system (GPS) coordinates of the unmanned aerial vehicle, marker beacon data along the flight route, and way point data along the flight route; and (5) flight mission data comprising: dimensional characteristics of the at least one product, dollar value of the at least one product, weight of the at least one product, weight of the unmanned aerial vehicle, component configuration of the unmanned aerial vehicle, altitude of the unmanned aerial vehicle, speed of the unmanned aerial vehicle, wind speed, temperature, light level, in-air objects along the flight route, distance to the in-air objects, angle of incidence relative to the in-air objects, remaining battery life of the unmanned aerial vehicle, start point of the unmanned aerial vehicle along the flight route, end point of the unmanned aerial vehicle along the flight route, original path of the unmanned aerial vehicle along the flight route, location of at least one mobile relay station along the flight route, location of at least one retail facility having a safe landing point along the flight route, and total dollar value of the unmanned aerial vehicle.

3. The system of claim 1, wherein the at least one sensor comprises an altimeter, velocimeter, thermometer, photocell, battery life sensor, camera, radar, lidar, laser range finder, and sonar.

4. The system of claim 1, wherein the control circuit of the unmanned aerial vehicle is programmed to analyze the at least one status input in order to determine a plurality of emergency landing locations comprising: an emergency landing location resulting from an unguided ballistic trajectory of the unmanned aerial vehicle if the unmanned aerial vehicle loses all power at the given point along the flight route; an emergency landing location resulting from a collision of the unmanned aerial vehicle with an in-air object that causes the unmanned aerial vehicle to lose all power at the given point along the flight route; an emergency landing location resulting from a guided trajectory of the unmanned aerial vehicle from the given point along the flight route; an emergency landing location resulting from an unguided ballistic trajectory of the unmanned aerial vehicle if the unmanned aerial vehicle loses all power at a given point along an altered flight route; an emergency landing location resulting from a collision of the unmanned aerial vehicle with an in-air object that causes the unmanned aerial vehicle to lose all power at the given point along the altered flight route; and an emergency landing location resulting from a guided trajectory of the unmanned aerial vehicle from the given point along the altered flight route.

5. The system of claim 4, wherein the control circuit of the unmanned aerial vehicle is programmed to identify, from the plurality of the determined emergency landing locations, an emergency landing location having a lowest collateral damage associated therewith.

6. The system of claim 5, wherein the collateral damage includes personal injury, and wherein the control circuit of the unmanned aerial vehicle is programmed to alter the flight route of the unmanned aerial vehicle prior to occurrence of the emergency condition in order to enable the unmanned aerial vehicle to land at an emergency landing location having lowest personal injury risk associated therewith.

7. The system of claim 5, wherein the collateral damage includes property damage, and wherein the control circuit of the unmanned aerial vehicle is programmed to alter the flight route of the unmanned aerial vehicle prior to occurrence of the emergency condition in order to enable the unmanned aerial vehicle to land at an emergency landing location having lowest property damage risk associated therewith.

8. The system of claim 5, wherein the collateral damage includes personal injury and property damage, and wherein the control circuit of the unmanned aerial vehicle is programmed to assess personal injury risk and calculate property damage risk associated with each of the plurality of the determined emergency landing locations, and identify, from the plurality of the determined emergency landing locations, an emergency landing location having a lowest combined personal injury risk and property damage risk associated therewith.

9. The system of claim 1, wherein the control circuit of the unmanned aerial vehicle is programmed to alter the flight route of the unmanned aerial vehicle prior to occurrence of the emergency condition and guide the unmanned aerial vehicle to a safe landing location in response to a determination by the computing device that the collateral damage is not acceptable.

10. The system of claim 1, wherein the control circuit of the computing device is programmed to transmit a second control signal from the computing device over the network to the unmanned aerial vehicle, the second control signal including an altered flight route for the unmanned aerial vehicle.

11. A method for facilitating a safe emergency landing of unmanned aerial vehicles flying along flight routes, the method comprising:
providing an unmanned aerial vehicle configured to transport at least one product to a delivery destination via a flight route, the unmanned aerial vehicle including at least one sensor configured to detect and transmit over a network at least one status input associated with the unmanned aerial vehicle during flight along the flight route;
providing a computing device including a processor-based control unit and in communication with the unmanned aerial vehicle over the network;
determining, via the computing device, the flight route for the unmanned aerial vehicle to deliver the at least one product to the delivery destination;
analyzing, via the computing device, the determined flight route of the unmanned aerial vehicle, prior to deployment of the unmanned aerial vehicle, in order to determine an emergency landing location where the unmanned aerial vehicle would land if unable to fly due to an emergency condition at a given point along the determined flight route;
transmitting, via the computing device, a first control signal over the network to the unmanned aerial vehicle, the first control signal including the determined flight route;
analyzing, via a processor-based control circuit of the unmanned aerial vehicle and while the unmanned aerial vehicle is in flight, the at least one status input in order to determine the emergency landing location where the unmanned aerial vehicle would land if unable to fly due to an emergency condition at a given point along the determined flight route;
evaluating, via the control circuit of the unmanned aerial vehicle, the collateral damage associated with an emergency landing of the unmanned aerial vehicle at the determined emergency landing location; and
altering, via the control circuit of the unmanned aerial vehicle, the flight route of the unmanned aerial vehicle to an alternative emergency landing location in response to a determination, by the control circuit of the unmanned aerial vehicle, that the alternative emergency landing location is associated with lower collateral damage compared to the determined emergency landing location.

12. The method of claim 11, wherein the at least one status input comprises at least one of: (1) weighted collateral damage aversion directives comprising: avoid personal injury upon landing, avoid damage to property upon landing, protect data upon landing, protect the at least one product upon landing, and protect the unmanned aerial vehicle upon landing; (2) drone status data comprising: propeller status, electronics status, communication status, interfering RF status; (3) map reference and topography data comprising: no fly zones along the flight route and on-ground buildings, hills, bodies of water, power lines, roads, vehicles, people, and known safe landing points along the flight route; (4) location data comprising: global positioning system (GPS) coordinates of the unmanned aerial vehicle, marker beacon data along the flight route, and way point data along the flight route; and (5) flight mission data comprising: dimensional characteristics of the at least one product, dollar value of the at least one product, weight of the at least one product, weight of the unmanned aerial vehicle, component configuration of the unmanned aerial vehicle, altitude of the unmanned aerial vehicle, speed of the unmanned aerial vehicle, wind speed, temperature, light level, in-air objects along the flight route, distance to the in-air objects, angle of incidence relative to the in-air objects, remaining battery life of the unmanned aerial vehicle, start point of the unmanned aerial vehicle along the flight route, end point of the unmanned aerial vehicle along the flight route, original path of the unmanned aerial vehicle along the flight route, location of at least one mobile relay station along the flight route, location of at least one retail facility having a safe landing point along the flight route, and total dollar value of the unmanned aerial vehicle.

13. The method of claim 11, wherein the at least one sensor comprises an altimeter, velocimeter, thermometer, photocell, battery life sensor, camera, radar, lidar, laser range finder, and sonar.

14. The method of claim 11, further comprising analyzing, via the control circuit of the unmanned aerial vehicle, the at least one status input in order to determine a plurality of emergency landing locations comprising: an emergency landing location resulting from an unguided ballistic trajectory of the unmanned aerial vehicle if the unmanned aerial vehicle loses all power at the given point along the flight route; an emergency landing location resulting from a collision of the unmanned aerial vehicle with an in-air object that causes the unmanned aerial vehicle to lose all power at the given point along the flight route; an emergency landing location resulting from a guided trajectory of the unmanned aerial vehicle from the given point along the flight route; an emergency landing location resulting from an unguided ballistic trajectory of the unmanned aerial vehicle if the unmanned aerial vehicle loses all power at a given point along an altered flight route; an emergency landing location resulting from a collision of the unmanned aerial vehicle with an in-air object that causes the unmanned aerial vehicle to lose all power at the given point along the altered flight route; and an emergency landing location resulting from a guided trajectory of the unmanned aerial vehicle from the given point along the altered flight route.

15. The method of claim 14, further comprising identifying, via the control circuit of the unmanned aerial vehicle, from the plurality of the determined emergency landing locations, an emergency landing location having lowest collateral damage associated therewith.

16. The method of claim 15, wherein the collateral damage includes personal injury, and wherein the altering step further comprises altering, via the unmanned aerial vehicle, the flight route of the unmanned aerial vehicle prior to occurrence of the emergency condition in order to enable the unmanned aerial vehicle to land at an emergency landing location having lowest personal injury risk associated therewith.

17. The method of claim 15, wherein the collateral damage includes property damage, and wherein the altering step further comprises altering, via the unmanned aerial vehicle, the flight route of the unmanned aerial vehicle prior to occurrence of the emergency condition in order to enable the unmanned aerial vehicle to land at an emergency landing location having lowest property damage risk associated therewith.

18. The method of claim 15, wherein the collateral damage includes personal injury and property damage, and wherein the analyzing by the control circuit of the unmanned aerial vehicle step further comprises assessing personal injury risk and calculating property damage risk associated with each of the plurality of the determined emergency landing locations, and identifying, from the plurality of the determined emergency landing locations, an emergency landing location having a lowest combined personal injury risk and property damage risk associated therewith.

19. The method of claim 11, wherein the altering step further comprises altering, via the unmanned aerial vehicle, the flight route of the unmanned aerial vehicle prior to occurrence of the emergency condition and guiding the unmanned aerial vehicle to a safe landing location in response to a determination by the computing device that the collateral damage is not acceptable.

20. The method of claim 11, wherein the altering step further comprises transmitting, from the computing device, a second control signal over the network to the unmanned aerial vehicle, the second control signal including an altered flight route for the unmanned aerial vehicle.
